(19) United States
(12) Patent Application Publication
(10) Pub. No.: US 2016/0214261 A1
(43) Pub. Date: Jul. 28, 2016

(54) COLLABORATIVE ROBOT SYSTEM AND METHOD

(71) Applicant: GM GLOBAL TECHNOLOGY OPERATIONS LLC, Detroit, MI (US)

(72) Inventors: Donald R. Davis, Novi, MI (US); Chris A. Ihrke, Hartland, MI (US); Douglas M. Linn, White Lake, MI (US); Jonathan Y. Chen, Troy, MI (US)

(73) Assignee: GM GLOBAL TECHNOLOGY OPERATIONS LLC, Detroit, MI (US)

(21) Appl. No.: 14/602,411

(22) Filed: Jan. 22, 2015

(51) Int. Cl. B25J 13/00; B25J 13/08

(52) U.S. Cl. CPC B25J 13/00; B25J 13/085

(57) ABSTRACT

A system for robot and human collaboration is provided. The system includes a robot having a programmed path for motion of the robot and a controller in communication with the robot. The controller has a processor and tangible, non-transitory memory on which is recorded instructions for an action to take when an unexpected contact between the robot and an object is detected. The controller is programmed to execute the instructions from the memory via the processor when the unexpected contact is detected, causing the robot to stop motion on a programmed path and to enter a push away mode. In the push away mode, the human can apply a push force having a push force direction to command the robot to move in the push force direction.

### TECHNICAL FIELD

The present disclosure relates to a system and method for robot and human collaboration.

### BACKGROUND

A collaborative robot is designed to work with or near a human to perform a variety of tasks. For example, a robot and a human may work together or may work in close proximity to perform vehicle manufacturing and assembly tasks. The human may work within or near the work space in which the robot and its attached end effectors or tooling and gripped parts, if any, are able to move. Existing collaborative robots stop moving when an unexpected contact is detected and have limited force and speed capabilities. Repeatability, accuracy, payload, and reach capabilities may also be limited. These limitations may render existing collaborative robots ineffective for many manufacturing and assembly operations.

It may be beneficial for collaborative robots to enter a push away mode when an unexpected contact is detected. The push away mode enables a human to easily push the collaborative robot away. It may also be beneficial for collaborative robots to back away along their programmed path before entering the push away mode if an unexpected contact is detected. The use of the back away operation and/or the push away mode when an unexpected contact is detected may enable the use of higher force and speed capability collaborative robots and may also improve collaborative robot repeatability, accuracy, payload, and reach capabilities.

### SUMMARY

A system for robot and human collaboration is disclosed herein, along with an associated method of using the same. The system includes a collaborative robot having a programmed path for motion of the robot and a controller in communication with the robot. The controller has a processor and tangible, non-transitory memory on which is recorded instructions for an action to take when an unexpected contact is detected between the robot and an object. The controller is programmed to execute the instructions from the memory via the processor when the unexpected contact is detected to stop motion of the robot on the programmed path and to enter a push away mode. In the push away mode, the human can apply a push force having a push force direction to command the robot to move in the push force direction.

Another embodiment of the system for robot and human collaboration includes a robot having a programmed path for motion of the robot and a controller in communication with the robot. The controller has a processor and tangible, non-transitory memory on which is recorded instructions for an action to take when an unexpected contact is detected between the robot and an object. The controller is programmed to execute the instructions from the memory via the processor when the unexpected contact is detected to stop forward motion of the robot on the programmed path, move the robot in reverse on the programmed path by a predetermined distance, and enter a push away mode. In the push away mode, the human can apply a push force having a push force direction to command the robot to move in the push force direction.

The method for operating a collaborative robot when an unexpected contact is detected between the robot and an object in the environment includes stopping, via a controller, forward motion of the robot on a programmed path and entering, via the controller, a push away mode. In the push away mode, a human can apply a push force having a push force direction to command the robot to move in the push force direction. The method may include commanding, via the controller, the robot to move in reverse on the programmed path by a predetermined distance after stopping forward motion of the robot on the programmed path and before entering the push away mode.

The system and method for robot and human collaboration disclosed herein, may improve the interaction between collaborative robots and humans. It may enable the use of higher force and speed capability collaborative robots and may also improve collaborative robot repeatability, accuracy, payload, and reach capabilities. The system and method may be used in the manufacture and assembly of vehicles. However this disclosure applies to any application of robot and human collaboration. Nonlimiting example applications include manufacturing, customer service, public service, and consumer applications.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic perspective illustration of a system for robot and human collaboration.

FIG. 2 is a flowchart depicting an example method of robot and human collaboration using the system shown in FIG. 1.

### DETAILED DESCRIPTION

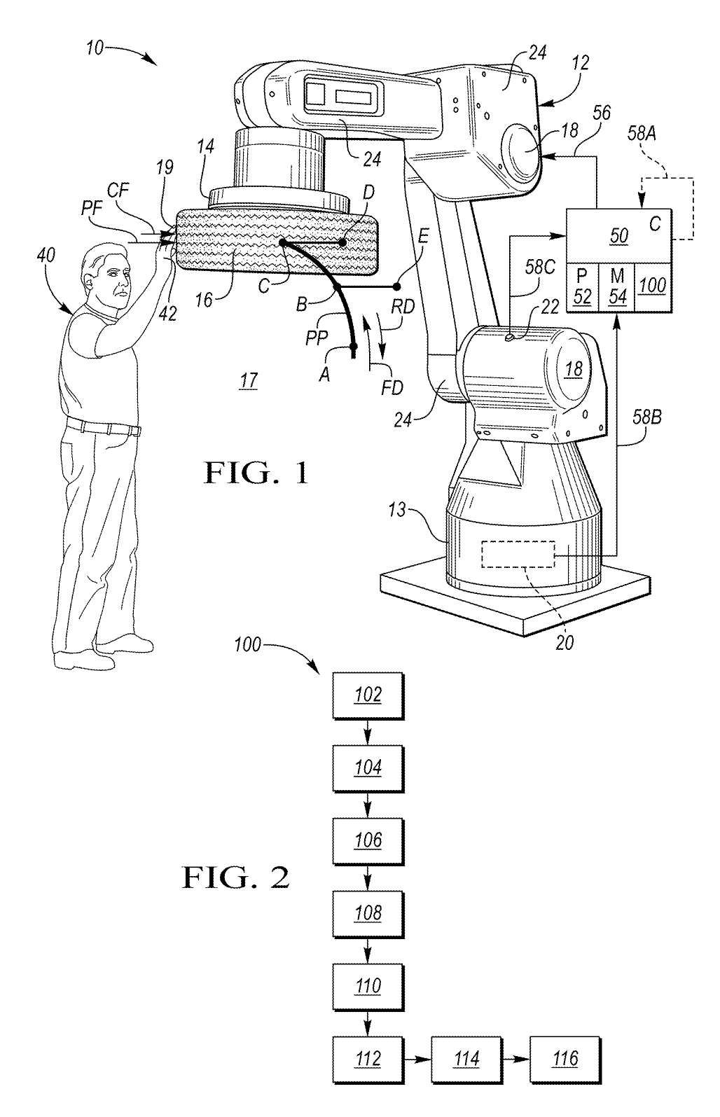

Referring to the drawings, wherein like reference numbers refer to like components, a system 10 for robot and human collaboration is shown in FIG. 1. The system 10 includes a robot 12. The robot 12 may be an electric robot, as shown, or may be any other type of robot. The robot 12 may have six degrees of freedom of motion, as shown, or have any other suitable number of degrees of freedom of motion, as understood by those skilled in the art. The robot 12 may have a base 13. The base 13 may be mounted to a floor, as shown, or may be mounted to a fixed structure (not shown), a piece of moving equipment (not shown), or any other suitable mounting surface or structure. An end effector 14 may be attached to the robot 12 to allow the robot 12 to grasp, move, and release a gripped part 16 or to perform a task, including but not limited to loading parts, unloading parts, assembling, adjusting, welding, and inspecting. While the end effector 14 is shown in FIG. 1 as a wheel gripper, the end effector 14, if any, is not limited to any particular gripper, tool, or device. Similarly, while the gripped part 16 is shown as a wheel in FIG. 1, the gripped part 16, if any, is not limited to any particular part, assembly, or component.

The robot 12 may include one or more servo motors 18 for moving the robot 12, the attached end effector 14, if any, and the gripped part 16, if any, on a programmed path PP. Other types of motors may be used as appropriate. The programmed path PP has a normal or forward direction FD and a reverse direction RD, which is opposite from the forward direction FD. For example, in the forward direction FD, the programmed path PP may pass through a point A, then through a point B, and then through a point C, where the points A, B, C are points in two or three dimensional space. Conversely, in the reverse direction RD, the programmed path PP may pass through the point C, then through the point B, and then through the point A. Similarly, the programmed path PP may include changes in angular positioning of the robot 12, as understood by those skilled in the art, as the robot 12 moves in the forward direction FD and as it moves in the reverse direction RD.

The robot 12, may include a force sensor 20. The force sensor 20 may be located near the base 13 of the robot 12, or may be located in other areas of the robot 12 as appropriate. The robot 12 may include more than one force sensor 20 which may be located in more than one area of the robot 12. The force sensor 20 may be a six degree of freedom load cell, a force sensor mounted on one or more outer surfaces of the robot, a force sensor based on motor torque monitoring, or any other appropriate force sensor.

A human operator 40 may be working with or near the robot 12. The human operator 40 has a hand 42 and other body parts. More specifically, the human 40 may be working in or near a work envelope or environment 17 of the robot 12. The work envelope or environment 17 of the robot, as known by those skilled in the art, includes any point in space that the robot 12, the end effector 14, if any, and the gripped part 16, if any, can contact or pass through. The robot 12, the end effector 14, if any, and the gripped part 16, if any, may contact an object 19 in the work envelope or environment 17. The object 19 may be a part of the human 40, as shown, or may be any other object in the environment 17, e.g., parts, tooling, and equipment. Contact between one of the robot 12, the end effector 14, if any, and the gripped part 16, if any, and the object 19 may be expected or unexpected. Expected contacts may occur during normal operation of the robot 12. Unexpected contacts may occur when the object 19 has unexpectedly entered the work envelope or environment 17 or is not in its normal position in the work envelope or environment 17. The robot 12 may include a resume button 22 for the human 40 to press to command the robot 12 to resume motion in the forward direction FD on the programmed path PP. The resume button 22 may be located on or near the robot 12 and may be a mechanical push button, as shown, an area on a touch sensitive screen (not shown), or any other suitable button, sensor, or switch.

The robot 12 may have a soft cover 24. The soft cover 24 may be made of a rubber, a plastic, a silicone, or any other suitable soft material. The soft cover 24 may cover all or part of the metal or hard exterior surfaces of the robot 12 and may reduce a peak force or a pressure resulting from an unexpected contact between the robot 12 and the object 19 in the work envelope or environment 17.

Still referring to FIG. 1, the system 10 includes a controller (C) 50 in communication with the robot 12. The controller 50 may be embodied as a computer device having a processor (P) 52 and memory (M) 54. Instructions embodying a method 100 are recorded on the memory 54 and are selectively executed by the processor 52 such that the controller 50 is programmed to execute all necessary steps of the method 100. The method 100 for operating a collaborative robot is described below with reference to FIG. 2. In a possible embodiment, the robot 12 is controlled via server motor control signals (arrow 56) in response to input signals (arrows 58A-C) transmitted into or otherwise received by the controller 50.

The input signals (arrows 58A-C) which drive the control steps executed by the controller 50 may be internally generated by the controller 50, e.g., as in the execution of the method 100 (arrow 58A), may include sensed information, e.g., as in a force signal (arrow 58B) from the force sensor 20, and/or may include commands from the human 40, e.g., as in a signal (arrow 58C) from the resume button 22.

The memory 54 may include tangible, non-transitory, computer-readable media such as read only memory (ROM), electrically-programmable read-only memory (EPROM), optical and/or magnetic media, flash memory, etc. Such memory is relatively permanent, and thus may be used to retain values needed for later access by the processor 52. Memory 54 may also include sufficient amounts of transitory memory in the form of random access memory (RAM) or any other non-transitory media. Memory 54 may also include any required position control logic, such as proportional-integral (PI) or proportional-integral-derivative (PID) control logic, one or more high-speed clocks, timers, analog-to-digital (A/D) circuitry, digital-to-analog (D/A) circuitry, a digital signal processor, and the necessary input/output (I/O) devices and other signal conditioning and/or buffer circuitry.

In operation, the robot 12, the end effector 14, if any, and the gripped part 16, if any, may have an unexpected contact with the object 19 in the work envelope or environment 17. The unexpected contact may be detected by the force sensor 20 or by other sensors including, but not limited to, touch sensors, vision sensors, radar sensors, and sonar sensors. The memory 54 includes recorded instructions for an action to take when the unexpected contact is detected. The controller 50 is programmed to execute the instructions from the memory 54 via the processor 42 when the unexpected contact is detected to stop motion of the robot 12 in the forward direction FD on the programmed path PP and to enter a push away mode. In the push away mode, the human 40 may apply a push force (arrow PF) having a push force direction (arrow PF) to command the robot 12 to move in the push force direction (arrow PF). The push force (arrow PF) may be applied to one or more of the robot 12, the end effector 14, if any, and the gripped part 16, if any.

For example, in operation the programmed path PP may pass through point A, then through point B, and then through point C. At point C, an unexpected contact may be detected. When the unexpected contact is detected, the controller 50 causes the robot 12 to stop motion in the forward direction FD on the programmed path PP at point C or to pause at point C. The controller 50 then causes the robot 12 to enter the push away mode. If the human 40 applies the push force (arrow PF) with the hand 42 or with any other body part one or more of the robot 12, the end effector 14, if any, and the gripped part 16, if any, the controller 50 causes the robot 12 to move in the push force direction (arrow PF) until the push force (arrow PF) ends. This may cause the robot 12 to move to a point D or to any other point where the human 40 pushes the robot 12.

In another embodiment, the controller 50 causes the robot 12 to move in the reverse direction RD on the programmed path PP by a predetermined distance after motion of the robot 12 in the forward direction FD on the programmed path PP is stopped and before entering the push away mode. For example, in operation the programmed path PP may pass through point A, then through point B, and then through point C. At point C, an unexpected contact may be detected. When the unexpected contact is detected, the controller 50 causes the robot 12 to stop motion in the forward direction FD on the programmed path PP at point C or to pause at point C. The controller 50 then causes the robot 12 to move in the reverse direction RD on the programmed path PP by a predetermined distance to the point B or to any other point in the reverse direction RD on the programmed path PP depending on the predetermined distance. The controller 50 then causes the robot 12 to enter the push away mode. If the human 40 applies the push force (arrow PF) with the hand 42 or any other body part to one or more of the robot 12, the end effector 14, if any, and the gripped part 16, if any, the controller 50 causes the robot 12 to move in the push force direction (arrow PF) until the push force (arrow PF) ends. This may cause the robot to move to a point E or to any other point where the human 40 pushes the robot 12.

The controller 50 may be programmed to receive the force signal 58B from the force sensor 20 and to detect the unexpected contact when the force signal 58B indicates a contact force (arrow CF). For example, when the robot 12 operates and no unexpected contact occurs, the force sensor 20 may detect an expected force. The expected force may be due to masses, positions, motions, expected contacts, and other factors of the robot 12, the end effector 14, if any, and the gripped part 16, if any. If an unexpected contact occurs, the contact force (arrow CF) may be added to the expected force detected by the force sensor 20. The controller 50 may be programmed to detect the unexpected contact when the force signal (arrow 58B) indicates a force that is different from the expected force due to the added contact force (arrow CF). The unexpected contact may be detected when the contact force (arrow CF) is more than a predetermined contact force. In an example embodiment, the predetermined contact force may be less than 20 pounds. In another example embodiment, the predetermined contact force may be between 5 pounds and 20 pounds. Other predetermined contact forces may be used as appropriate.

The controller 50 may be programmed to receive the force signal (arrow 58B) from the force sensor 20 to detect the push force (arrow PF). For example, when the robot 12 is stopped, the force sensor 20 may detect an expected force. The expected force may be due to masses, positions, and other factors of the robot 12, the end effector 14, if any, and the gripped part 16, if any. The controller 50 may be programmed to detect the push force (arrow PF) when the force signal (arrow 58B) indicates a force that is different from the expected force when the robot 12 is stopped or paused. The push force (arrow PF) to move the robot 12 may be more than a predetermined push force. In an example embodiment, the predetermined push force may be less than 10 pounds. In another example embodiment, the predetermined push force may be 8 pounds. Other predetermined push forces may be used as appropriate. The predetermined push force may be the same as the predetermined contact force or may be different from the predetermined contact force as appropriate.

Referring now to FIG. 2, an example method for operating the collaborative robot 12, described above, commences with step 102. Before step 102, the robot 12 is moving in the normal or forward direction FD on the programmed path PP, as described above. At step 102, an unexpected contact is detected between the robot 12 and an object 19 in the work envelope or environment 17 while proceeding in the forward direction FD on the programmed path PP. The unexpected contact may be detected by the force sensor 20, described above, or by other sensors including, but not limited to, touch sensors, vision sensors, radar sensors, and sonar sensors.

At step 104, motion of the robot 12 in the forward direction FD on the programmed path PP is stopped or paused, via the controller 50, described above. The motion of the robot 12 in the forward direction FD on the programmed path PP may be stopped immediately after the unexpected contact is detected. At step 106, the controller 50 may command the robot 12 to move in the reverse direction RD on the programmed path PP by a predetermined distance. In an example embodiment, step 106 may be included in the method 100 if the contact force (arrow CF) is greater than the predetermined contact force by at least a first predetermined threshold force.

At step 108, a push away mode is entered, via the controller 50. In the push away mode, the human 40 can apply a push force (arrow PF) having a push force direction (arrow PF) to one or more of the robot 12, the end effector 14, if any, and the gripped part 16, if any, to command the robot 12 to move in the push force direction (arrow PF). At step 110, the push force (arrow PF) is detected by the force sensor 20 or by other sensors including, but not limited to, touch sensors, vision sensors, radar sensors, and sonar sensors. At step 112, one or more servo motors 18 in the robot 12 move the robot 12 in the push force direction (arrow PF) until the push force (arrow PF) ends.

At step 114, the controller 50 may detect a pressing of the resume button 22, described above. The resume button 22 may be pressed by the human 40 when the human 40 is ready for the robot 12 to resume motion in the forward direction FD on the programmed path PP. In certain instances, the controller 50 may command the robot 12 to resume motion in the forward direction FD on the programmed path PP without the pressing of the resume button 22 by the human 40. For example, if the contact force (arrow CF) is greater than the predetermined contact force by no more than a second predetermined threshold force, the controller 50 may command the robot 12 to resume motion in the forward direction FD on the programmed path PP if the contact force (arrow CF) is no longer detected at a predetermined time after the unexpected contact. At step 116, the robot 12 resumes motion in the forward direction FD on the programmed path PP.

While the best modes for carrying out the many aspects of the present teachings have been described in detail, those familiar with the art to which these teachings relate will recognize various alternative aspects for practicing the present teachings that are within the scope of the appended claims.

1. A system for robot and human collaboration, comprising:
a robot having a programmed path for motion of the robot; and
a controller in communication with the robot and including a processor and tangible, non-transitory memory on which is recorded instructions for an action to take when an unexpected contact is detected between the robot and an object;
wherein the controller is programmed to execute the instructions from the memory via the processor when the unexpected contact is detected to:
stop motion of the robot on the programmed path; and
enter a push away mode, wherein the human applies a push force having a push force direction to command the robot to move in the push force direction.

2. The system of claim 1, further comprising a force sensor;
wherein the controller is further programmed to receive a force signal from the force sensor and to detect the unexpected contact when the force signal indicates a contact force.

3. The system of claim 2, wherein the unexpected contact is detected when the contact force is more than a predetermined contact force.

4. The system of claim 3, where the predetermined contact force is between 5 pounds and 20 pounds.

5. The system of claim 2, wherein the controller is further programmed to receive the force signal from the force sensor to detect the push force.

6. The system of claim 5, wherein the robot has a soft cover.

7. The system of claim 5, wherein the push force to move the robot is more than a predetermined push force.

8. The system of claim 7, wherein the predetermined push force is less than 10 pounds.

9. The system of claim 1, wherein the controller is further programmed to move the robot in a reverse direction on the programmed path by a predetermined distance after stopping motion of the robot on the programmed path and before entering the push away mode.

10. The system of claim 9, further comprising a force sensor;
wherein the controller is further programmed to receive a force signal from the force sensor and to detect the unexpected contact when the force signal indicates a contact force.

11. The system of claim 10, wherein the unexpected contact is detected when the contact force is more than a predetermined contact force.

12. The system of claim 10, wherein the controller is further programmed to receive the force signal from the force sensor to detect the push force.

13. The system of claim 12, wherein the robot has a soft cover.

14. The system of claim 12, wherein the push force to move the robot is more than a predetermined push force.

15. A method for operating a robot in an environment, comprising:
detecting an unexpected contact between the robot and an object in the environment;
stopping, via a controller, motion of the robot in a forward direction on a programmed path; and
entering, via the controller, a push away mode, wherein a human applies a push force having a push force direction to command the robot to move in the push force direction.

16. The method of claim 15, further comprising commanding, via the controller, the robot to move in a reverse direction on the programmed path by a predetermined distance after stopping motion in the forward direction on the programmed path and before entering the push away mode.

17. The method of claim 15, wherein detecting the unexpected contact includes using a force sensor.

18. The method of claim 15, further comprising detecting the push force with a force sensor.

19. The method of claim 15, further comprising using a servo motor in the robot to move the robot in the push force direction.

20. The method of claim 15, further comprising:
detecting, via the controller, a pressing of a resume button; and
resuming, via the controller, motion of the robot in the forward direction on the programmed path.
